(19) United States
(12) Patent Application Publication
(10) Pub. No.: US 2026/0033423 A1
(43) Pub. Date: Feb. 5, 2026

(54) DRIVER ASSISTANCE SYSTEM FOR AN AGRICULTURAL WORK MACHINE

(71) Applicant: CLAAS Selbstfahrende Erntemaschinen GmbH, Harsewinkel (DE)

(72) Inventors: Andreas Wilken, Bissendorf (DE); Henner Vöcking, Rietberg (DE); Christoph Bussmann, Harsewinkel (DE); Bastian Bormann, Gütersloh (DE); Matthias Domnik, Oelde (DE); Joachim Baumgarten, Beelen (DE); Patrick Schulze Vohren, Sassenberg (DE); Sascha Dieckmeyer, Melle (DE)

(73) Assignee: CLAAS Selbstfahrende Erntemaschinen GmbH, Harsewinkel (DE)

(21) Appl. No.: 19/286,900

(22) Filed: Jul. 31, 2025

(30) Foreign Application Priority Data
Jul. 31, 2024 (DE) 10 2024 121 764.2

(51) Int. Cl. A01D 41/127

(52) U.S. Cl. CPC A01D 41/127

(57) ABSTRACT

A driver assistance system for an agricultural work machine. The driver assistance system includes at least one control and regulation device, which is configured for an optimization process of work parameter and/or quality parameters of the agricultural working machine using performance maps saved therein. The optimization process is performed by specifying a process control strategy selectable by an operator. The driver assistance system is configured to detect a conflict of objectives during the execution of the optimization process and to interact with an operator of the agricultural work machine in order to resolve the conflict of objectives.

### CROSS REFERENCE TO RELATED APPLICATION

This application claims priority under 35 U.S.C. § 119 to German Patent Application No. DE 10 2024 121 764.2 filed Jul. 31, 2024, the entire disclosure of which is hereby incorporated by reference herein.

### TECHNICAL FIELD

The present invention relates to a driver assistance system for an agricultural working machine.

### BACKGROUND

This section is intended to introduce various aspects of the art, which may be associated with exemplary embodiments of the present disclosure. This discussion is believed to assist in providing a framework to facilitate a better understanding of particular aspects of the present disclosure. Accordingly, it should be understood that this section should be read in this light, and not necessarily as admissions of prior art.

Monitoring and optimizing work and quality parameters of an agricultural work machine may be performed using a control and regulation device. Optimization processes that run automatically and access performance maps may be used for this purpose. The performance maps may be saved in the control and regulation device or a computer unit. Typically, an operator may specify a selectable process control strategy. The automated optimization process of at least one work parameter and/or quality parameter of the agricultural work machine may then be performed.

### BRIEF DESCRIPTION OF THE DRAWINGS

The present application is further described in the detailed description which follows, in reference to the noted drawings by way of non-limiting examples of exemplary embodiment, in which like reference numerals represent similar parts throughout the several views of the drawings, and wherein:

FIG. 1 illustrates an example schematic representation of an agricultural work machine designed as a combine harvester.

FIG. 2 illustrates an example schematic representation of a display structure of a control and regulation device.

FIG. 3 illustrates an example schematic representation of a mathematical model.

FIG. 4 illustrates an example schematic representation of a conflict of objectives.

FIG. 5 illustrates an example schematic representation of a resolution of the conflict of objectives.

### DETAILED DESCRIPTION

As discussed in the background, responsive to operator specifying a selectable process control strategy, the automated optimization process of at least one work parameter and/or quality parameter of the agricultural work machine may then take place so that during operation of the agricultural work machine in performing a harvesting process (e.g., harvesting corn, wheat, rice, etc.). In this regard, the automated optimization process may be performed dynamically and in real-time at least partly during the harvesting process. However, typical optimization processes may reach their limits and may be unable to perform when no satisfactory result may be achieved within the selected process control strategy. This is often the case if the properties of the material to be harvested deviate from the harvested material properties normally expected or if the nature of the territory to be worked, such as sloping terrain, has a negative effect on the operation of the working units. In this case, the automated optimization process may fail during the harvesting process, which may in turn result in less efficiency in performing the harvesting process.

Thus, in one or some embodiments, a driver assistance system with at least one control and regulation device to at least partly address such circumstances. In particular, in one or some embodiments, a driver assistance system for an agricultural work machine is disclosed with at least one control and regulation device, which is configured for an optimization process of work parameters and/or quality parameters of the agricultural working machine using performance maps saved therein. The optimization process may be performed by specifying a process control strategy that may be selected by an operator (e.g., a selected optimization process). In one or some embodiments, the process control strategy may be specified prior to beginning the harvesting process. Alternatively, the process control strategy may be specified at least partly during the harvesting process. Regardless, responsive to the selection, the driver assistance system is configured to automatically detect a conflicting objective at least partly during the execution of the optimization process and to automatically interact with an operator of the agricultural work machine in order to resolve the conflict of objectives. In one or some embodiments, the driver assistance system is configured to automatically detect a conflicting objective at least partly while the agricultural work machine is performing the harvesting process, and is configured to automatically interact with the operator during performing the harvesting process. In this way, the conflict may be resolved by operator input during performing the harvesting process. Further, in this way, the driver assistance system may be configured to automatically control one or more of the working units to control operation of the agricultural work machine at least partly during performing the harvesting process using the determined work parameters and/or quality parameters, resulting in greater efficiency. As such, the automatic detecting of the conflict, the automatic resolution of the conflict, and the automatic revision of operation of the agricultural work machine may be performed dynamically and in real-time while performing the harvesting process.

In one or some embodiments, the driver assistance system may comprise an additional electronic device in the agricultural work machine to support the operator or driver. Alternatively, the driver assistance system is integrated within the electronics of the agricultural work machine. Thus, any discussion herein regarding the driver assistance system may equally apply to either configuration. Regardless, the driver assistance system may be designed as semi-autonomous or autonomous. The driver assistance system may be directly connected to working units of the agricultural work machine (e.g., the driver assistance system may automatically send commands to one or more actuators in order to automatically control operations of the working units). Alternatively, the driver assistance system may automatically send the commands via an intermediate device in order to automatically control operations of the working units.

In one or some embodiments, the working units may be configured to perform specific sub-work processes of an overall work process for processing harvested materials. In so doing, each working unit may be assigned a specific sub-work process. A sub-work process may be, for example, a threshing process, a separating process or a cleaning process. The overall work process may comprise a plurality of sub-work processes. The overall work process may relate to all steps for processing harvested materials (e.g., threshing, separating, cleaning, etc.). The operator may transmit information in the form of input via a user interface (e.g., a touchscreen) to the driver assistance system and/or the control and regulation device.

The process control strategy may refer to the planned and systematic approach to optimize the harvesting of agricultural products. The process control strategy may be oriented towards any one, any combination, or all of: maximum harvested material flow; minimum fuel consumption; high threshing quality; or a balanced operating point. The process control strategy may include selecting the best timing, appropriate methods and the necessary equipment to maximize the quality and quantity of the harvest. By selecting a process control strategy once, the way to control the working units may be specified. Further, input from the operator need not be required to determine the setting parameters (e.g., the determination may be automatic). However, the operator may have the option to change the selected process control strategy if desired so that autonomous control may then continue to occur, but possibly with a different prioritization.

In one or some embodiments, the optimization process may have the goal of determining the setting parameters of the working units in order to achieve a goal of the process control strategy. In one or some embodiments, the optimization process may be automated (e.g., fully automated (without any user input other than selection of the process control strategy) or partially automated (such as with the option for user input or user confirmation). The optimization process of work parameters and/or quality parameters may be designed in such a way that sensors continuously and automatically detect data indicative of the operating conditions and/or the performance of the agricultural work machine. Algorithms of the optimization process may analyze this data to identify patterns and deviations and, responsive to the analysis, automatically adjust one or more of the machine parameters (in order to modify operation of one or more of the working units) to improve efficiency and quality. During the optimization process, decisions may be made independently or autonomously, and parameters such as work speed, cutting height or grain size may potentially be adjusted in real time to ensure optimal results under varying conditions. In one or some embodiments, the optimization process may be executed automatically and autonomously using the control and regulation device or a computing unit (e.g., without operator intervention). The optimization process may be performed based on a set of rules or a controller structure.

In one or some embodiments, the performance maps may be data that is saved in the control and regulation device. The control and regulation device may include at least one memory, such as a standard digital storage medium, for example a digital memory module or a memory drive. Saved performance maps may contain information that, when accessed by the driver assistance system, may be used to control and/or optimize the operation of the driver assistance system and/or the operation of the agricultural work machine. Performance maps may show or indicate a relationship between different operating parameters, for example work parameters and/or quality parameters, which may be in the form of characteristic curves. In one or some embodiments, the performance maps may comprise several characteristic curves. Characteristic curves may each represent different states or settings of the agricultural work machine and may enable the analysis and optimization of the operating behavior. Performance maps may be used, for example, in fields such as engine technology or electrical engineering to visualize and understand the performance and efficiency of the agricultural work machine under different conditions.

Work parameters and/or quality parameters of an agricultural work machine may be specific measured variables and properties that evaluate and optimize the operation and performance of the agricultural work machine. Work parameters may include, for example, any one, any combination, or all of the work speed, the work width, the fuel consumption, or the workload of the agricultural work machine. Quality parameters may include any one, any combination, or all of the cutting height during mowing, the grain size during harvesting, or the purity of the harvested product or harvested material.

The conflict of objectives may be a conflict that arises when an objective is set and this objective cannot be achieved. For example, a conflict of objectives may arise if the optimization process has an objective that cannot be achieved during the execution of the optimization process. The driver assistance system may automatically detect this conflict of objectives and automatically initiate an interaction with the operator. For example, the driver assistance system may prompt the operator to provide an input. Advantageously, in so doing the process knowledge of the operator may be provided via the interaction. This may mean that the operator may incorporate their expertise and experience directly into the harvesting process by interacting with the driver assistance system.

As one example, the operator may transmit specific settings and adjustments to the driver assistance system (which may still maintain the selectable process control strategy that was previously selected by the operator, but provide additional input in order to perform the previously selected process control strategy). As another example, the operator may provide input as to a different process control strategy (so that the previously selected process control strategy is dynamically changed at least partly while performing the harvesting process). Regardless, the interaction with the operator may be aimed at resolving the conflict of objectives by acquiring a problem solution or a suggestion from the operator via the interaction. Conflict resolution using the interaction may mean that the operator and driver assistance system jointly identify problems and develop solutions.

In one or some embodiments, the interaction may also be designed in such a way that the driver assistance system initially provides data and suggestions for solving the problem, while the operator may make the final decision and, if necessary, performs adjustments (e.g., the operator provides the input indicating the adjustments; responsive to the input, the driver assistance system automatically implements the adjustments). The interaction may include, for example, pressing buttons, turning knobs, pulling levers, touching screens, speaking voice commands, swiveling joysticks, clicking mouse buttons, drawing on touchpads, adjusting switches, moving sliders, swiping screens, reading displays, entering codes, adjusting settings, scrolling pages, double-clicking icons, flashing LEDs, scrolling pages, turning dials, and/or navigating menus.

In one or some embodiments, the driver assistance system is configured to automatically identify that the conflict of objectives comprises a lack of information. The lack of information may lead to a stoppage of the optimization process (e.g., a temporary stoppage of the optimization process while performing the harvesting process). Once resolved using the input from the operator, the driver assistance system may restart the optimization process while performing the same harvesting process. Furthermore, the conflict of objectives may optionally comprise a failure to achieve a target.

The lack of information may mean, for example, that the optimization process may no longer be continued (at least temporarily while performing the harvesting process) because the information for further implementation is missing. It may therefore be that the optimization process may have to be stopped or interrupted after a while because the information that is required for further optimization is missing. The information may, for example, be boundary conditions, parameters and/or measured values. In such an instance, the driver assistance system may output the conflict to the operator and may also output the type of conflict (e.g., a conflict of objectives comprising a lack of information). In this regard, the request to the operator may seek to obtain the information lacking, such as the boundary conditions, the parameters and/or the measured values. Further, because of the intelligence of the driver assistance system (in determining the conflict and in temporarily modifying the optimization process (such as by temporarily halting the optimization process)), once the missing information is provided by the operator, the driver assistance system may resume the optimization process while performing the harvesting process so that the harvesting process may be perform more efficiently both during the conflict period (e.g., in which the information is missing) and after the conflict period.

The target specification may be the specification of a goal, such as a clear, specific instruction or a desired result that is to be achieved. The target specification may specify what performances, qualities or timeframes are expected. For example, the target specification may have been established or identified by an operator or by the control and regulation system. In one or some embodiments, the target specification may be determined from the process control strategy. Further, the target specification may be changeable during the optimization process, for example by the operator.

In one or some embodiments, interaction with the operator may resolve the conflict of objectives in the form of providing part or all of the missing information or failure to achieve the target specification. In this regard, in response to the query to the operator, the missing information may, for example, be added by the operator. Furthermore, the target specification may be adjusted by the operator, such as if it becomes apparent during the optimization process that the target specification cannot be achieved. As such, the driver assistance system, in soliciting input from the operator, may request from the operator the missing information and/or a modified target specification. Thus, the operator may change the target specification in such a way that the target specification may be achieved in the optimization process from a physical point of view.

In one or some embodiments, the driver assistance system includes a sensor system with a plurality of sensors in order to generate sensor data for acquiring at least one work parameter and/or quality parameter. In this regard, the sensor system may be configured to detect the sensor data indicative of the conflict of objectives during the execution of the optimization process. The conflict of objectives may include any one, any combination, or all of: a defect of a sensor and/or the control and regulation device; an erroneous measured value detected by a sensor; or a calibration error of a sensor.

The sensor may be a technical component that may detect certain physical or chemical properties (physical, e.g., amount of heat, temperature, humidity, pressure, sound field sizes, brightness, acceleration) and/or the material nature of its environment qualitatively or quantitatively as a measured variable. Data detected by a sensor (e.g., work parameter and/or quality parameters) may be transmitted (e.g., wired and/or wirelessly) to the driver assistance system and/or the control and regulation device. In other words, the control and regulation device may perform calculations using the data detected by the sensor. The at least one work parameter and/or quality parameter detected by the sensor may be made available to the optimization process.

In one or some embodiments, the driver assistance system is configured to perform the optimization process that comprises: reducing or minimizing a difference between a target variable and a target specification, wherein the target variable is determined based on a mathematical model and a plurality of setting parameters.

The mathematical model may map functional relationships between a target variable and a plurality of setting parameters. The driver assistance system may be configured to determine the one target variable or at least one setting parameter based on the mathematical model. Furthermore, a difference may be formed or determined between the target variable and the target specifications, for example in the form of a loss function. The loss function may be reduced or minimized during the optimization process by varying stepwise the input variables of the mathematical model, such as the setting parameters, for example. It is therefore possible for the target variable to be changed while the target specification remains fixed. Therefore, the difference between the target specification and the objective may be changed stepwise.

In one or some embodiments, the driver assistance system may be configured to interact with the operator of the agricultural work machine by an “ex cabin” action or an “off cabin” action. An “ex cabin” action may be an action that may be performed within the vehicle cab of the agricultural work machine. In other words, the operator may not need to leave the vehicle cab to perform an “ex cabin” action. The “ex cabin” action may be the actuation of a control element, wherein the control element is located inside the vehicle cab. Advantageously, an “ex cabin” action may be performed quickly because the operator may perform the action directly from the vehicle cab. An “off cabin” action may be an action that involves an action or activity outside the vehicle cab of the agricultural work machine. The “off cabin” action may require the operator to get out of the vehicle cab and perform the action on the agricultural work machine. For example, the “off cabin” action may be the actuation of a lever or switching device outside the vehicle cab. The “off cabin” action may be a cleaning action of a sensor or the alignment of a working unit. In particular, the driver assistance system may inform or notify the operator which action (e.g., “ex cabin” action or “off cabin” action) is to be performed.

In one or some embodiments, the driver assistance system may be configured to interact with the operator of the agricultural work machine by any one, any combination, or all of: automatically communicating the conflict of objectives so that the conflict of objectives is detectable or identifiable by the operator; automatically prompting to reduce or eliminate the conflict of objectives; automatically prompting the operator to provide information about the material to be harvested; or prompting to provide information about a machine parameter if the machine parameter cannot be detected by the agricultural work machine.

The conflict of objectives may be communicated, for example, in such a way that a display and/or a warning tone is emitted by the driver assistance system (e.g., via a touchscreen display). The display may be detected visually and the warning tone acoustically by the operator. After the communication of the conflict of objectives, the operator may be informed that there is a conflict of objectives that may be resolved by means of an interaction. Prompting may include a request to the operator to actively perform something on the agricultural work machine itself. The prompt may also be a request to provide further information. For example, it may be information about the material to be harvested, such as moisture or cutting length. It may also be information about a missing machine parameter, for example if the driver assistance system recognizes that data detected by a sensor may not be available. For example, a driver assistance system may recognize that the agricultural work machine is not equipped with the necessary sensors or that a sensor is defective. The operator may be prompted to repair, clean and/or obtain one or more sensors. Alternatively, or in addition, the operator may be prompted to provide the input in place of the sensor data.

In one or some embodiments, the driver assistance system is configured to interact with the operator of the agricultural work machine by automatically changing settings of the optimization process. The changing may relate to any one, any combination, or all of the following: weighting of objectives; starting values of optimization parameters; relaxation of requirements or restrictions; or use of compromise solutions. In other words, the operator may change the settings (e.g., setting parameters) of the optimization process so that the optimization may continue. The operator may redefine starting values for optimization parameters to take into account the current operating point or the specific conditions of the current field. By relaxing requirements or constraints, such as the tolerance for the target specification, the operator may increase the possibility of overcoming the conflict of objectives. Finally, the use of compromise solutions may enable the consideration of multiple competing goals or target specifications by allowing the operator to find an optimal compromise through interaction, such as between fuel consumption and harvesting quality. These flexible adaptation options through interaction may allow the operator to respond to a variety of situations and conditions in real time.

In one or some embodiments, the driver assistance system may be configured to overcome the conflict of objectives by providing information to the driver assistance system via the interaction with the operator of the agricultural work machine. The information may comprise any one, any combination, or all of the following: setting of work parameter and/or quality parameters; field boundaries and/or working areas; working speed; change of working modes; adaptation to environmental conditions; or status information of the agricultural work machine.

The setting of the work parameter and/or quality parameters may, for example, relate to the adjustment of operating parameters of the agricultural work machine, such as threshing drum speed, sieve settings and cutting height, to ensure optimum performance and desired harvesting quality. Field boundaries and/or work areas may refer to the specific geographical boundaries and zones of a field within which the agricultural work machine operates. The operating speed may refer to the speed at which the agricultural work machine operates to maximize efficiency and productivity during operation. Changing working modes may, for example, refer to changing from plowing to sowing or from harvesting to transporting, depending on the requirements of the work process. Adaptation to environmental conditions may refer to the option for the agricultural work machine to adjust operating parameters such as cutting height or fan rotational speed to potentially respond to changing environmental conditions such as soil moisture or wind speed and optimize the efficiency of the operation. The status information of the agricultural work machine may include information about the current state of the machine such as engine power, oil level and/or wearing parts, which may help the operator monitor the maintenance needs of the machine and pursue timely measures to minimize downtime. In one or some embodiments, by using this information, it may be possible to adapt the agricultural work machine to specific field conditions and harvesting requirements, which may lead to more efficient resource utilization and higher harvested material quality.

In one or some embodiments, the driver assistance system includes an actuator system. In this case, the actuator system may be configured to resolve the conflict of objectives using the interaction with the operator of the agricultural work machine. In particular, the control and regulation device may be in communication with (e.g., wired and/or wirelessly transmit commands to) the actuator system or the plurality of actuators. In this way, the control and regulation device may transmit signals or commands directly to the actuator system. In one or some embodiments, an actuator may be a drive unit that converts an electrical signal (e.g., commands issued by the driver assistance system) into mechanical movements or changes in physical variables (e.g., pressure or temperature) and therefore may actively intervene in a controlled process. Examples of actuators may be valves, cylinders (e.g., pneumatic cylinders, hydraulic cylinders, electric cylinders), electromechanical drives, electric motors or piezo elements. The actuator may be part of the working unit or embedded in the working unit. For example, the actuator may be a hydraulic motor that drives a threshing drum of the combine harvester.

In one or some embodiments, the actuator system may directly implement the measures specified by the operator that may be necessary to resolve the conflict of objectives. This may lead to a particularly fast and efficient implementation of resolving the conflict of objectives. Furthermore, using the actuator system, the driver assistance system may have a direct influence on the agricultural work machine and may therefore resolve conflicts of objectives more easily.

In one or some embodiments, the driver assistance system may be configured to interact with the operator of the agricultural work machine in natural language. This may mean, for example, that the operator conveys his instructions and adjustments in natural, spoken language instead of using complex controls or input devices. Voice commands may potentially allow the operator to effortlessly adjust parameters such as threshing drum speed, sieve settings or driving speed by simply speaking and thereby interacting with the driver assistance system. This form of interaction may facilitate operation and may enable intuitive and quick adjustment to the current conditions in the harvesting process, thereby increasing the efficiency and user-friendliness of the agricultural work machine.

Thus, in one or some embodiments, an agricultural work machine may include a driver assistance system as discussed herein. Further, in one or some embodiments, a method for operating a driver assistance system of an agricultural work machine is disclosed. The method may comprise automatically detecting a conflict of objectives at least partly while performing the optimization process; and at least partly automatically interacting with an operator of the agricultural work machine. The interacting may be for the purpose of overcoming the conflict of objectives. In one or some embodiments, the interacting may comprise inputting or outputting information. In one or some embodiments, the method comprises a computer-implemented method, wherein the control and regulation device is configured to automatically perform the computer-implemented method.

In general, the described method may also apply to a corresponding device for performing the method or a corresponding system that comprises one or more devices, and vice versa. For example, if a particular method step is described, a corresponding device may contain a feature for performing the described method step, even if this feature is not explicitly described or shown in the figure. On the other hand, if, for example, a particular device is described on the basis of functional units, a corresponding method may contain one or more steps for performing the described functionality even if these steps are not explicitly described or shown in the figures. Similarly, a system may include a corresponding device feature or features for performing a particular step of the method. The features of the various exemplary aspects and embodiments described above or below may be combined, provided that something different is not explicitly stated.

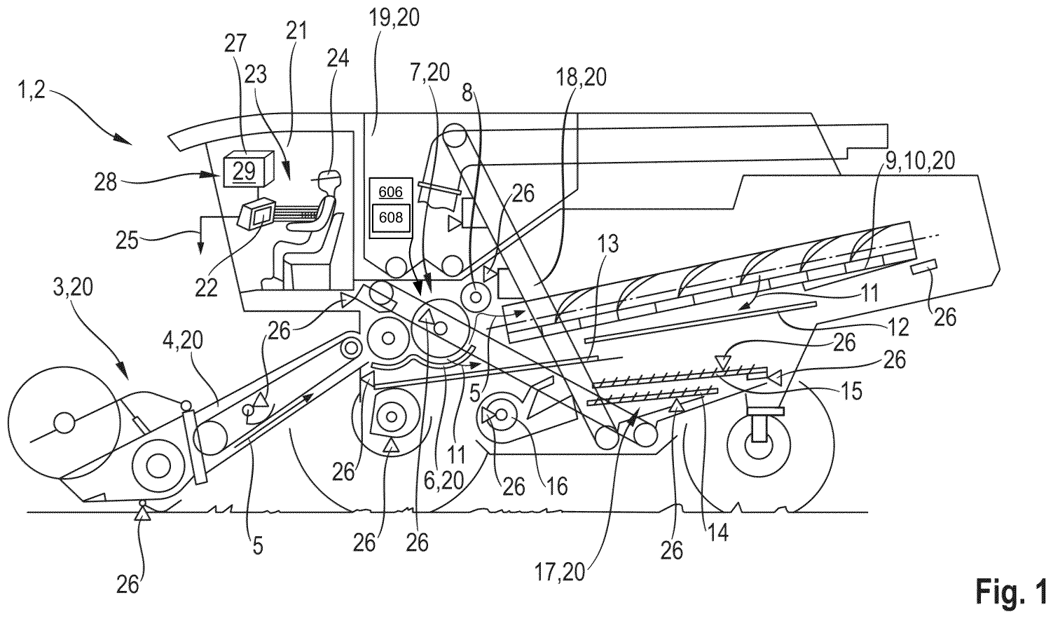

Referring to the figures, FIG. 1 illustrates an example agricultural work machine 1. Further, U.S. Pat. No. 9,002,594 B2, incorporated by reference herein in its entirety, likewise discloses an agricultural work machine.

The agricultural work machine 1 may comprise a combine 2 (alternatively termed a combine harvester) that is schematically represented in FIG. 1. For example, the combine may perform the harvesting process, which may comprise a plurality of separate harvesting operations, such as any one, any combination, or all of reaping, threshing, winnowing, and gathering into the harvesting process. The combine 2 may receive or have attached thereto a grain header 3 in its front region that is connected in a known manner to the inclined conveyor 4 of the combine 2. The flow of harvested material 5 passing through the inclined conveyor 4 may be transferred in the upper rear region of the inclined conveyor 4 to the threshing units 7 of the combine 2, which may at least be partially surrounded by a so-called threshing concave 6 on the bottom. A diverter roller 8 downstream from the threshing units 7 may divert the flow of material 5 out of the threshing units 7 in their rearward region so that the flow may be immediately transferred to a separating device 10 designed as a separating rotor 9. The flow of material 5 in the rotating separating rotor 9 may be conveyed such that freely movable grains 11 contained in the flow of material 5 are removed in the bottom region of the separating rotor 9. In one or some embodiments, the separating device 10, portrayed in the depicted embodiment may be designed as a separating rotor 9, may also be designed as a known, and therefore not shown, straw walker. The grains 11 deposited both on the threshing concave 6 and on the separating rotor 9 may be fed over a returns pan 12 and a feed pan 13 of a cleaning device 17 comprising (or consisting of) a plurality of screening levels 14, 15 and a blower 16. The cleaned flow of grains may then be transferred using elevators 18 to a grain tank 19. In one or some embodiments, the working units 20 of the agricultural working machine 1 may comprise any one, any combination, or all of the grain header 3, the inclined conveyor 4, the threshing units 7 and the threshing concave 6 assigned to them, the separating device 10, the cleaning device 17, the elevators 18 and the grain tank 19.

Furthermore, the agricultural working machine 1 may include a vehicle cab 21 in which is arranged or positioned at least one control and regulation device 23 provided with a display unit 22, through which a plurality of processes (which are known per se and are therefore not further explained) may be controlled, initiated automatically or by an operator 24 of the agricultural working machine 1. The control and regulation device 23 may communicate with a plurality of sensor systems 26 via a bus system 25 in a manner known per se. Details relating to the structure of the sensor systems 26 are described in detail in U.S. Pat. No. 6,863,604 B2, the entire content of which is hereby incorporated by reference herein. Moreover, the control and regulation device 23 may be coupled to a driver assistance system 28, which may comprise a display unit 27. Alternatively, the driver assistance system 28 may also be integrated directly in the control and regulation device 23, and the information 29 provided by the driver assistance system 28 and explained in greater detail below may also be visualized directly in the display unit 22 assigned to the control and regulation device 23. In this regard, any discussion regarding the control and regulation device 23 and the driver assistance system 28 may include the confirmation in which the control and regulation device 23 and the driver assistance system 28 are separate devices or in which the control and regulation device 23 and the driver assistance system 28 are integrated and effectively a single device performing the functions of both. Examples of driver assistance systems are in US Patent Application Publication No. 2023/0397533 A1; US Patent Application Publication No. 2024/0065155 A1; US Patent Application Publication No. 2025/0057068 A1; and US Patent Application Publication No. 2025/0057079 A1, each of which are incorporated by reference herein in their entirety.

The combine harvester 2 may also include an actuator system 606 with a plurality of actuators 608. The actuators 608 may each be part of one of the working units 20 or be embedded in the working units 20. For example, one of the actuators 608 is a hydraulic motor that drives the threshing unit 7 of the combine harvester 2. In each case, one of the working units 20 may be controlled via one actuator 608.

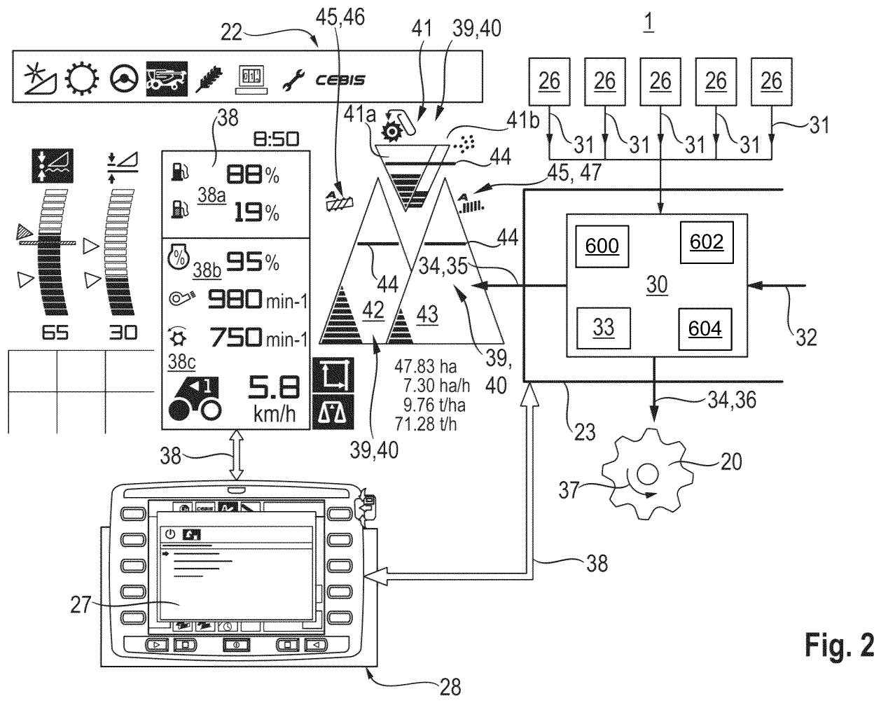

FIG. 2 illustrates a schematic representation of the display unit 22 of the control and regulation device 23 and the computing unit 30 associated with the control and regulation device 23 and coupled to the display unit 22. The computing unit may comprise computing functionality, and may include at least one processor 600, at least one memory 602, and at least one communication interface 604. The memory 602 may be configured to store data, such as the external information 32 and the information 33, and/or computer-executable instructions stored on the tangible memory. Moreover, the communication interface 604 may be configured to communicate with devices external to the control and regulation device 23, such as driver assistance system 28, actuator(s) 608, other electronic devices, or the like.

The processor 600 and the memory 602 may be in communication (e.g., wired and/or wirelessly) with one another. In one or some embodiments, the processor 600 may comprise a microprocessor, controller, PLA, or the like. Similarly, the memory 602 may comprise any type of storage device (e.g., any type of memory, such as RAM, ROM, or a combination thereof). Though the processor 600 and the memory 602 are depicted as separate elements, they may be part of a single machine, which includes a microprocessor (or other type of controller) and a memory. Alternatively, the processor 600 may rely on the memory 602 for all of its memory needs. The memory 602 may comprise a tangible computer-readable medium that include software that, when executed by the processor 600 is configured to perform any one, any combination, or all of the functionality described herein.

The processor 600 and the memory 602 are merely one example of a computational configuration for the electronic devices discussed herein. Other types of computational configurations are contemplated. For example, all or parts of the implementations may be circuitry that includes a type of processor, including an instruction processor, such as a Central Processing Unit (CPU), microcontroller, or a microprocessor; or as an Application Specific Integrated Circuit (ASIC), Programmable Logic Device (PLD), or Field Programmable Gate Array (FPGA); or as circuitry that includes discrete logic or other circuit components, including analog circuit components, digital circuit components or both; or any combination thereof. The circuitry may include discrete interconnected hardware components or may be combined on a single integrated circuit die, distributed among multiple integrated circuit dies, or implemented in a Multiple Chip Module (MCM) of multiple integrated circuit dies in a common package, as examples.

In this regard, the computing unit 30 may be configured to process any one, any combination, or all of the internal information 31 generated by the sensor systems 26, the external information 32, and the information 33 saved in the computing unit 30 itself, such as expert knowledge, into a plurality of output signals 34. The output signals 34 may comprise at least display control signals 35 and/or working unit control signals 36, wherein the display control signals 35 determines the contents of the display unit 22 and the working unit control signals 36 causes the change in the various work parameters 37 of the working units 20 of the agricultural work machine 1. The arrow 37 may symbolically represent the threshing drum rotational speed. In addition, as previously described, the control and regulation device 23 may be coupled to the driver assistance system 28, with the driver assistance system 28 being integrated into the agricultural work machine 1 in such a way that the driver assistance system 28 may exchange data 38 in a manner to be described in more detail both with the control and regulation device 23 and with the display unit 22 associated therewith. Thus, in one or some embodiments, the control and regulation device 23 and the driver assistance system 28 may be part of the same computing unit 30, and may have different computer threads being executed in the processor 600 for the respective functions performed for the control and regulation device 23 and the driver assistance system 28. Alternatively, the control and regulation device 23 and the driver assistance system 28 may be executed on different computing units, in which case the driver assistance system 28 has its own processor 600, memory 602, and communication interface 604.

Display unit 22 may comprise an input device and/or an output device. Examples of input/output device 50 may comprise a touchscreen and/or a speaker (e.g., for generating the interaction with the operator, as discussed herein). The contents of the display units 22, 27 shown in FIG. 2 are exemplary and are described in more detail below. In its central region, the display unit 22 assigned to the control and regulation device 23 may comprise a so-called hotkey window 38 freely definable by the operator 24 and in which important machine information, such as the fill level of the fuel tank 38a, machine parameter settings 38b and the travel speed 38c are visualized.

The display unit 22 may comprise display elements 39 in its right-sided region for visualizing current values of certain quality parameters 40 of the agricultural work machine 1. In the depicted embodiment, the display element 39 arranged at the top visualizes the composition of the so-called “returns” 41, whereby the left-sided display visualizes the “returns volume” 41a and the right-sided display visualizes the “grain proportion in the returns” 41b. The lower, left-hand display element 39 may visualize the so-called “separation losses” 42, such as those grain losses that are discharged from the separating device 10 designed as a separating rotor 9 or straw walker, in the rear region of the agricultural work machine 1 and are not conveyed into the grain tank 19. The lower, right-hand display element 39 may visualize the so-called “cleaning losses” 43, wherein those grain losses may be displayed here and which may be discharged from the agricultural work machine 1 by the cleaning device 17 in a manner analogous to the separating device 10 and are not conveyed into the grain tank 19. Each of the display elements 39 may also comprise a setpoint indicator 44 designed as a horizontal line, which may define the maximum permissible loss level of the given quality parameter 40 previously defined by the operator 24 so that the operator 24 may quickly determine whether the agricultural work machine 1 has a sufficient working quality.

The control and regulation device 23 of the driver assistance system 28 may be configured for an automatable optimization process of work parameter(s) and/or quality parameter(s) of the agricultural work machine 1 using performance maps saved therein. An automated optimization process of at least one work parameter and/or at least one quality parameter of the agricultural work machine 1 may be performed by specifying a process control strategy selectable by the operator 24. The driver assistance system 28 may be configured to automatically detect a conflict of objectives during the execution of the optimization process and to interact with an operator 24 of the agricultural working machine 1 in order to resolve the conflict of objectives.

For example, the operator 24 may select a maximum material flow 5 for the combine harvester 2 as a process control strategy. The control and regulation device 23 may then automatically perform an optimization process with the aim of determining the setting parameters for the working units 20. The setting parameters may be, for example, a threshing drum rotational speed, a threshing concave width, a rotor rotational speed, a fan rotational speed and/or a position of a rotor cover.

To determine the setting parameters, a mathematical model may be provided that forms functional relationships between a target variable and a plurality of setting parameters. In the present case, the target variable may be the maximum material flow 5. It may be provided that a target specification is specified by the process control strategy or by the operator 24. For example, the target specification may refer to the fact that a maximum material flow 5 of 40 tons per hour is to be achieved. A difference may be formed between the target variable and the target specification. In one step, the optimization process may comprise minimizing the difference between the target variable and the target specification, wherein the target variable may be determined based on the mathematical model and the plurality of setting parameters. This may be achieved by an algorithm that calculates the target variable based on the mathematical model, wherein the input variables of the mathematical model, such as the setting parameters, may be varied step by step. In this regard, the target variable may be changed while the target specification remains fixed. Therefore, the difference between the target specification and the objective may be changed stepwise. The driver assistance system 28 may be configured to automatically detect a conflict of objectives during the execution of the optimization process and to automatically interact with the operator 24 of the combine harvester 2 in order to resolve the conflict of objectives.

For example, the driver assistance system 28 may automatically detect that the target specification is not being achieved. If, for example, the target specification is not reached after a predetermined optimization time, the driver assistance system 28 may automatically classify that there is a conflict of objectives. The driver assistance system 28 may automatically detect the conflict of objectives, automatically stop the optimization process and automatically initiate an interaction with the operator 24. A prompt may be automatically displayed to the operator 24 using the display unit 27. For example, the driver assistance system 28 may automatically prompt the operator 24 to provide an input. In response to the prompt, the operator may enter a new target specification, such as a different value for the maximum material flow 5. For example, the operator 24 may enter the value 20 tons per hour for the maximum material flow 5. The operator 24 has the option of changing the target specification in such a way that the target specification may be achieved in the optimization process from a physical point of view. In this way, the process knowledge of the operator 24 (e.g., about the maximum material flow 5) may advantageously be provided via the interaction. This may mean that the operator 24 may incorporate their expertise and experience directly into the harvesting process by interacting with the driver assistance system 28. Therefore, the operator 24 may contribute to resolving the conflict of objectives via the interaction with the driver assistance system 28. In one or some embodiments, the interaction with the operator 24 may be done in a natural language. This may mean, for example, that the operator 24 conveys the value for the maximum material flow 5 in natural, spoken language instead of manually entering it into the driver assistance system 28.

Alternatively, the driver assistance system 28 may detect that the conflict of objectives depend on an unfavorable machine parameter. For example, it may be that at a certain value of a machine parameter for a working unit, the target specification, such as a maximum good flow 5, cannot be achieved, regardless of which setting parameters are determined using the optimization process. The driver assistance system 28 may automatically detect that the machine parameter is not suitable for achieving the target specification. The driver assistance system 28 may automatically initiate an interaction with the operator 24, wherein the interaction with the operator 24 may comprise an “ex cabin” action or an “off cabin” action.

The “ex cabin” action may be an action that may be performed from the vehicle cab 21 of the combine harvester 2 and for which the operator 24 does not have to leave the vehicle cab 21. The “ex cabin” action may be the actuation of a control element, wherein the control element is located inside the vehicle cab 21. Once the control element has been actuated, the actuator system may directly implement the measures that are required to resolve the conflict of objectives. This may lead to a particularly fast and efficient implementation of resolving the conflict of objectives.

The “off cabin” action may require the operator 24 to exit the vehicle cab 21 and perform an action in the combine harvester 2. For example, the “off cabin” action may be the actuation of a lever or switching device outside the vehicle cab 21.

Alternatively, the driver assistance system 28 may automatically detect that the conflict of objectives involves a lack of information. The lack of information may optionally lead to a stoppage of the optimization process. For example, it is possible that a sensor of the sensor system 26 is defective or dirty. This may mean that no data or faulty data is recorded by the sensor system 26. The driver assistance system 28 may automatically recognize that the information provided by the sensor system 26 is missing or incorrect. As a result, the operator 24 may be automatically prompted to repair and/or clean one or more sensors of the sensor system 26. After the operator has repaired or cleaned the sensor, the driver assistance system 28 may automatically collect information that is necessary for the optimization process. The conflict of objectives may therefore be resolved.

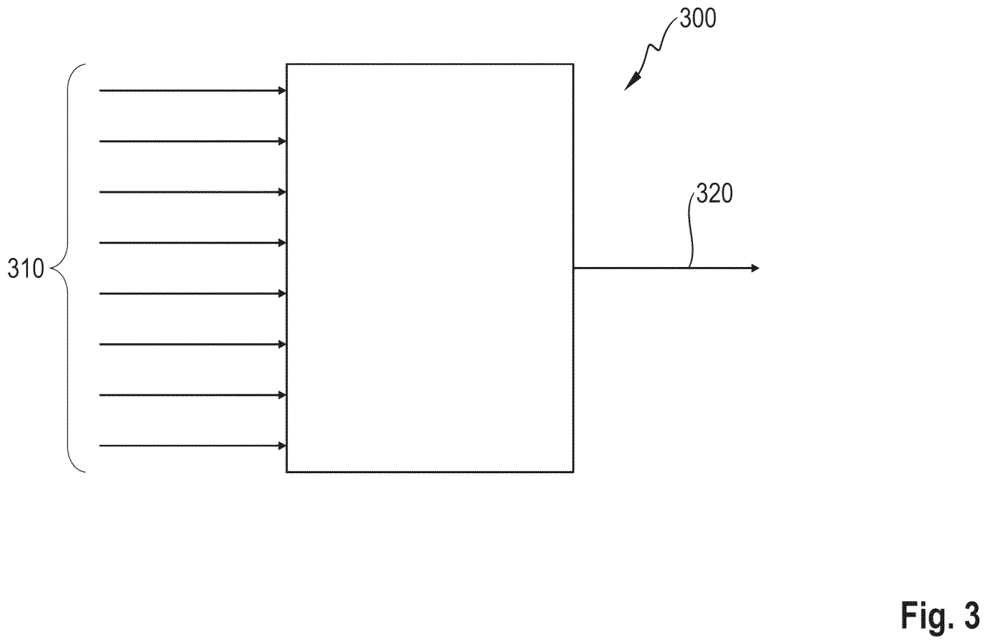

FIG. 3 illustrates an example schematic representation of a mathematical model 300. The mathematical model 300 may map functional relationships between a target variable 320 and a plurality of setting parameters 310. The driver assistance system 28 may be configured to determine the target variable 320 based on the mathematical model 300 and a plurality of setting parameters 310. In the simplest case, the mathematical model 300 is a regression model.

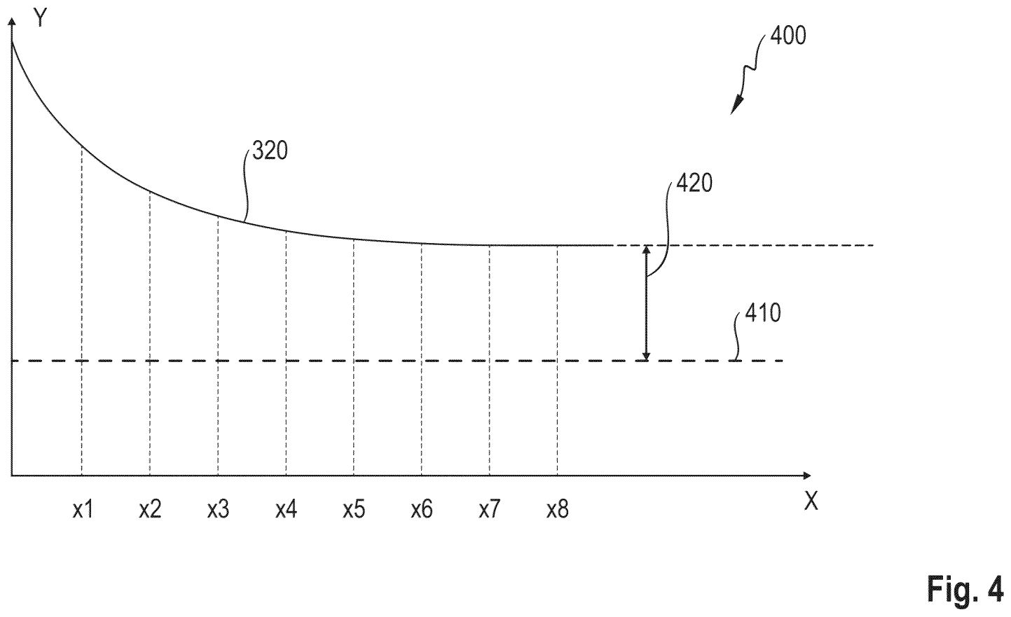

FIG. 4 illustrates an example schematic representation of a conflict of objectives 400 (or conflicting targets). During the optimization process, the target variable 320 may be calculated using the mathematical model 300 for various optimization steps x1 to x8. The objective of the optimization process may be that the target variable 320 reaches a target specification 410. To this end, the setting parameters 310 may be varied step by step. This may mean that the target variable 320 is automatically determined for each optimization step x1 to x8 with different values for the setting parameters 310. The target specification 410 may remain fixed, such as a fixed value is specified for the target specification 410. An example of the target specification may comprise a minimum fuel consumption.

In one or some embodiments, the target specification 410 is unable to be achieved during the optimization process. Accordingly, a gap 420 (also referred to as an “offset”) may occur between the target variable 320 and the target specification 410, which may continue to exist even after a long optimization or optimization time. The driver assistance system 28 may automatically detect that the target variable 320 is not reached in that the gap 420 is detected. In this way, the driver assistance system 28 may automatically detect a conflicting objective 400.

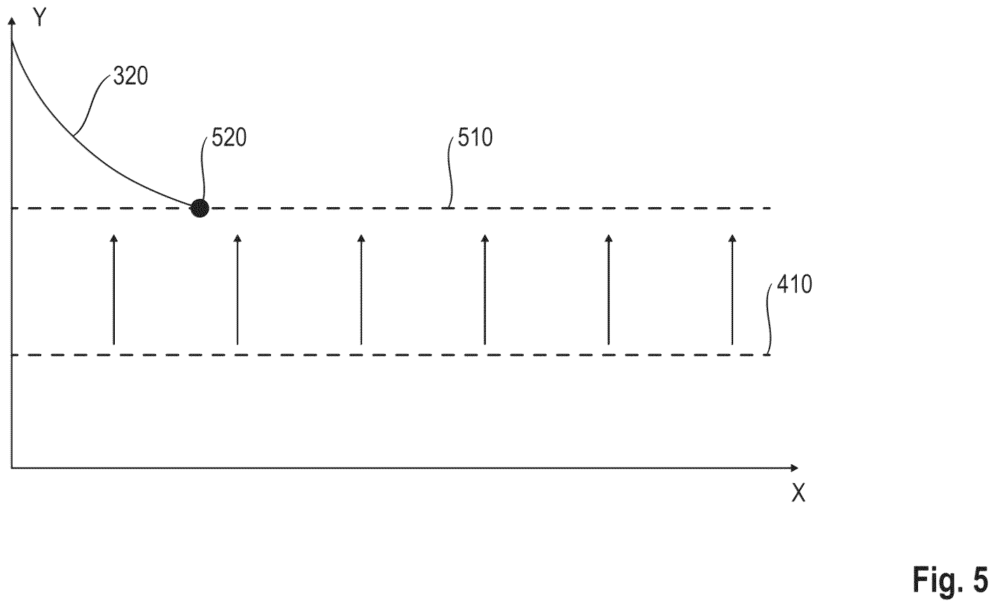

FIG. 5 illustrates an example schematic representation of a resolution of the conflict of objectives. In one or some embodiments, the operator 24 may change a setting of the optimization process by interacting via a touchscreen or the like with the driver assistance system 28 in order to resolve the conflict of objectives. For example, the operator may change the target specification 410 by specifying a new target specification 510. The operator 24 may therefore relax or revise the requirements for the optimization. The optimization process may then be restarted, wherein the new target specification 510 may be taken into account. During the optimization process, the target variable 320 may be calculated, and the setting parameters 310 may be varied until a point 520 is reached at which the target variable 320 corresponds to the new target variable 510. The conflict of objectives 400 may therefore be resolved.

Further, it is intended that the foregoing detailed description be understood as an illustration of selected forms that the invention may take and not as a definition of the invention. It is only the following claims, including all equivalents, that are intended to define the scope of the claimed invention. Further, it should be noted that any aspect of any of the preferred embodiments described herein may be used alone or in combination with one another. Finally, persons skilled in the art will readily recognize that in preferred implementation, some, or all of the steps in the disclosed method are performed using a computer so that the methodology is computer implemented. In such cases, the resulting physical properties model may be downloaded or saved to computer storage.

List of Reference Numbers

| | | | |
|---|---|---|---|
| 1 | Agricultural work machine | 31 | Internal information |
| 2 | Combine harvester | 32 | External information |
| 3 | Grain header | 33 | Information |
| 4 | Inclined conveyor | 34 | Output signal |
| 5 | Harvested material flow | 35 | Display signal |
| 6 | Threshing concave | 36 | Working unit signal |
| 7 | Threshing unit | 37 | Operating parameter |
| 8 | Deflection drum | 38 | Hotkey window |
| 9 | Separating rotor | 39 | Display element |
| 10 | Separating device | 40 | Quality parameter |
| 11 | Grains | 41 | Returns |
| 12 | Returns pan | 41a | Returns volume |
| 13 | Feed pan | 41b | Grain content in the returns |
| 14 | Screening level | 42 | Separation loss |
| 15 | Screening level | 43 | Cleaning loss |
| 16 | Fan | 44 | Target value display |
| 17 | Cleaning device | | |
| 18 | Elevator | | |
| 19 | Grain tank | | |
| 20 | Working unit | | |
| 21 | Vehicle cabin | | |
| 22 | Display unit | | |
| 23 | Control and regulation device | | |
| 24 | Operator | | |
| 25 | Bus system | | |
| 26 | Sensor system | | |
| 27 | Display unit | | |
| 28 | Driver assistance system | | |
| 29 | Information | | |
| 30 | Computing unit | | |
| 300 | Mathematical model | | |
| 310 | Settings | | |
| 320 | Target variable | | |
| 400 | Conflict of objectives | | |
| 410 | Target specification | | |
| 420 | Gap | | |
| 510 | New target specification | | |
| 520 | Point | | |
| 600 | Processor | | |
| 602 | Memory | | |
| 604 | Communication interface | | |
| 606 | Actuator system | | |
| 608 | Actuators | | |
| x1 | Optimization step | | |
| x2 | Optimization step | | |
| x3 | Optimization step | | |
| x4 | Optimization step | | |
| x5 | Optimization step | | |
| x6 | Optimization step | | |
| x7 | Optimization step | | |
| x8 | Optimization step | | |

1. An agricultural work machine comprising:
one or more working units;
a driver assistance system configured to:
automatically access a selectable process control strategy that is selected by an operator;
automatically perform, using the selectable process control strategy and one or more performance maps, an optimization process in order to select one or both of at least one work parameter or at least one quality parameter for the agricultural work machine;
automatically detect, responsive to automatically performing the optimization process, a conflict of one or more objectives;
responsive to automatically detecting the conflict, automatically interact with an operator of the agricultural work machine in order to resolve the conflict;
receive input from the operator in order to resolve the conflict; and
automatically perform, using the selectable process control strategy, the one or more performance maps, and the input from the operator, the optimization process in order to select the one or both of the at least one work parameter or the at least one quality parameter for the agricultural work machine; and
at least one control and regulation device in communication with the driver assistance system and configured to automatically, using the one or both of the at least one work parameter or the at least one quality parameter, control the one or more working units.

2. The agricultural work machine of claim 1, wherein the conflict of one or more objectives comprises a lack of information.

3. The agricultural work machine of claim 2, wherein the lack of information leads to one or both of a stoppage of the optimization process or a failure to reach a target for the optimization process.

4. The agricultural work machine of claim 1, wherein the driver assistance system comprises a sensor system with one or more sensors configured to detect sensor data indicative of the one or both of the at least one work parameter or the at least one quality parameter; and
wherein the driver assistance system is configured to automatically detect the conflict of the one or more objectives by automatically analyzing the sensor data.

5. The agricultural work machine of claim 4, wherein the conflict of the one or more objectives comprises one or more of:
a defect of at least one of the one or more sensors;
a defect in the control and regulation device;
an erroneous measured value detected by at least one of the one or more sensors; or
a calibration error of the at least one of the one or more sensors.

6. The agricultural work machine of claim 1, wherein the optimization process comprises reducing or minimizing a difference between a target variable and a target specification; and
wherein the driver assistance system, in performing the optimization process, is configured to determine the target variable based on a mathematical model (300) and a plurality of setting parameters.

7. The agricultural work machine of claim 1, further comprising a cabin; and
wherein the interaction with the operator of the agricultural work machine comprises an action within the cabin or an action outside of the cabin.

8. The agricultural work machine of claim 1, wherein the interaction with the operator of the agricultural working machine comprises one or more of:
communicating the conflict of the one or more objectives to the operator;
prompting the operator to eliminate a conflicting target that is included in the conflict of the one or more objectives;
prompting the operator to provide information about material to be harvested in order to resolve the conflict; or
responsive to the conflict comprising an inability of the agricultural work machine to automatically detect a respective machine parameter, prompting the operator to provide information about the respective machine parameter.

9. The agricultural work machine of claim 1, wherein the interaction with the operator of the agricultural working machine comprises each of:
communicating the conflict of the one or more objectives to the operator;
prompting the operator to eliminate a conflicting target that is included in the conflict of the one or more objectives;
prompting the operator to provide information about material to be harvested in order to resolve the conflict; and
responsive to the conflict comprising an inability of the agricultural work machine to automatically detect a respective machine parameter, prompting the operator to provide information about the respective machine parameter.

10. The agricultural work machine of claim 1, wherein the interaction with the operator of the agricultural working machine comprises requesting the operator to change the one or both of the at least one work parameter or the at least one quality parameter of the optimization process.

11. The agricultural work machine of claim 10, wherein the interaction with the operator is requesting to change one or more of the following:
weighting of the one or more objectives;
starting values of the at least one work parameter or the at least one quality parameter of the optimization process;
relaxation of requirements or restrictions in the optimization process; or
use of compromise solutions in the optimization process.

12. The agricultural work machine of claim 10, wherein the interaction with the operator is requesting to change each of the following:
weighting of the one or more objectives;
starting values of the at least one work parameter or the at least one quality parameter of the optimization process;
relaxation of requirements or restrictions in the optimization process; and
use of compromise solutions in the optimization process.

13. The agricultural work machine of claim 1, wherein the driver assistance system is configured to resolve the conflict of the one or more objectives using information provided by the operator to the driver assistance system responsive to the interacting with the operator of the agricultural work machine;
wherein the agricultural work machine is in an area; and
wherein the information comprises one or more of the following:
setting of the one or both of the at least one work parameter or the at least one quality parameter;
one or both of field boundaries or working areas of the area;
working speed of the agricultural work machine;
change of a respective working mode of the agricultural work machine;
adaptation to one or more environmental conditions; or
status information of the agricultural work machine indicative of a current state of the agricultural work machine.

14. The agricultural work machine of claim 1, wherein the conflict of the one or more objectives is resolved using information provided by the operator to the driver assistance system responsive to the interacting with the operator of the agricultural work machine;
wherein the agricultural work machine is in an area; and
wherein the information comprises each of the following:
setting of the one or both of the at least one work parameter or the at least one quality parameter;
one or both of field boundaries or working areas of the area;
working speed of the agricultural work machine;
change of a respective working mode of the agricultural work machine;
adaptation to one or more environmental conditions; or
status information of the agricultural work machine indicative of a current state of the agricultural work machine.

15. The agricultural work machine of claim 1, further comprising an actuator system; and
wherein the actuator system, responsive to control from the driver assistance system based on the interaction with the operator, is configured to reduce or eliminate the conflict of the one or more objectives.

16. The agricultural work machine of claim 1, wherein the interaction with the operator of the agricultural working machine is in natural language.

17. The agricultural work machine of claim 1, wherein the agricultural work machine is configured to perform a harvesting process;
wherein the driver assistance system is configured to detect in real-time the conflict at least partly while performing the harvesting process;
wherein the driver assistance system is configured to automatically interact in real-time with the operator of the agricultural work machine in order to resolve the conflict at least partly while performing the harvesting process;
wherein the driver assistance system is configured to receive the input from the operator in real-time in order to resolve the conflict at least partly while performing the harvesting process;
wherein the driver assistance system is configured to automatically perform the optimization process in real-time at least partly while performing the harvesting process; and
wherein the at least one control and regulation device is configured to automatically control the one or more working units in real-time at least partly while performing the harvesting process.

18. The agricultural work machine of claim 17, wherein, responsive to automatically determining the conflict, the driver assistance system is configured to automatically modify the optimization process in real-time at least partly while performing the harvesting process; and
responsive to resolving the conflict, the driver assistance system is configured to automatically resume the optimization process in real-time at least partly while performing the harvesting process.

19. The agricultural work machine of claim 18, wherein the driver assistance system is configured to automatically modify the optimization process in real-time by stopping the optimization process.
